(19) United States
(12) Patent Application Publication
(10) Pub. No.: US 2005/0177379 A1
(43) Pub. Date: Aug. 11, 2005

(54) Music delivery system

(76) Inventor: Leonard J. Gaik, Hamilton (CA)

Correspondence Address: DIMOCK STRATTON LLP, 20 QUEEN STREET WEST SUITE 3202, BOX 102, TORONTO, ON, M5H 3R3, CA

(21) Appl. No.: 10/772,439

(22) Filed: Feb. 6, 2004

(51) Int. Cl. G06F 17/60

(52) U.S. Cl. 705/1

(57) ABSTRACT

A business method is provided for conducting a business transaction between a provider of music and an operator of a public medium comprising the step of arranging for the purchase of a right to play a selection of music in the public medium at a pre-determined time for a pre-determined length of time by the provider from the operator. Public media on which music can be played in accordance with the present invention include of retail stores, bars, sports stadiums, sports arenas, cell phones and personal communication device ring tones, phone line holding ports and on-line websites. Providers of music in accordance with the present invention include record companies, record producers, music publishing companies, record distribution companies, recording studios, individual artists, music providers and agents for musical artists.

### FIELD OF THE INVENTION

The invention relates to a method of arranging for a provision of music from a provider of music to an operator of a public medium.

### BACKGROUND OF THE INVENTION

The delivery of music to public places is pervasive in our society. Music is often performed in public through radio, television and Internet broadcasts. It is also regularly played in public places such as retail stores, sporting events, entertainment events, bars and event theatres to list just a few examples. In addition, music is delivered to members of the public through personal communication media such as on-hold telephone music and mobile phone ring tones.

Owners of public places such as retailers regularly play music in their premises in order to create an ambient environment that is pleasant and entices customers to spend more time in their stores or locations. A positive ambient environment also creates a favorable association in the minds of customers with a retailer's store and wares or with an owner's establishment such as a bar. It is therefore very important for owners of establishments or other media that are open to the public to acquire an appropriate assortment of music that creates the ambient atmosphere that they wish to create.

The owners of establishments rarely own or control the music that they play in their premises. Copyright laws in the United States, Canada and Western Europe protect musical works. The owner of the copyright is generally entitled to receive a licensing fee when the copyrighted work is played in public. In the United States, the United Kingdom and Canada, these fees are collected by public performance or copyright collectives on behalf of and distributed to the owners of the copyrights in the musical compositions and audio and/or audiovisual recordings that the music embodies. In the United States, the public performance collectives include BMI, ASCAP and SESAC. In Canada, the collective is SOCAN while in the United Kingdom it is PRS.

Due to the existence of copyright collectives, owners must pay the applicable license fees to them. The rate is determined by the copyright collective.

Most owners have difficulty in determining the appropriate music to play in their public space. As a result, the owners have, prior to this invention, most often paid a separate and additional fee to a third party music provider for such third party to provide the owner with music which could be played in their public space. Such third parties that charge to provide music to owners have become known as “music providers”. Music providers include some well-known U.S. companies such as Muzak LLC, DMX Music, Play Network Inc. and Music Choice. Music providers will for a fee, program and deliver music to the owner for the performance of the music in the owner's public space.

In some instances, the music provider will be responsible for paying the license fee to the copyright collective. These fees would be paid from the fees received from the owner. In other instances, the owner must pay the licensing fees directly to the copyright collective in addition to fees charged by a music provider.

The present arrangement for owners of publicly accessible premises or media to acquire musical selections has several drawbacks. Firstly, the arrangement is quite costly for these owners. The cost to owners is elevated because they have to pay licensing fees in addition to the cost of the third party music provider that merely obtains music with the permission of the appropriate copyright collective and/or copyright owner and makes selections of music for the owner. The arrangement is also not ideal for copyright owners such as record companies because they have little ability to influence where owners or music providers will play their music. This is due to the fact that the music provider most often selects the music that will be provided to the owner based on the type of environment or ambiance that the owner wishes to have in its premises.

There is therefore a need for a method of providing music to owners of publicly available premises that is more cost effective for owners. There is a need for such a method that removes the inefficiencies caused by the involvement of a third party music provider. There is a further need for such a system that benefits the owners of the music by allowing them to direct where their music will be played.

### SUMMARY OF THE INVENTION

The present invention is a business method for conducting a transaction between an operator of a public medium and a provider of music. The method involves the sale of the right to play music in the operator's publicly accessible medium to a provider of music. The music can be in any of a number of different formats including recorded music, live simulcast musical audio and audio-visual content. The provider of music is entitled to the public performance of such music within the owner's medium which can include for example a public space, location, internet site and a device such as a cellular telephone owned and/or controlled by a person selling either as a principal or via a principal-agency relationship. According to the present invention there is preferably no cost to members of the public for accessing the music through the public medium. It is not necessary for the member of the public to make any purchase or to provide any other form of consideration for accessing the music through the public medium.

According to one aspect of the present invention there is provided a business method that involves the acquisition by a provider of music from the owner of a medium accessible by the public of a right to play its music in that medium.

According to another aspect of the present invention, there is provided a method of arranging for a provision of music from a provider of music to an operator of a public medium comprising the following steps:
acquiring from the operator a right to play a selection of music in said public medium at a pre-determined time for a pre-determined length of time; and
transfering said right to play music to the provider of music.

According to another aspect of the present invention, there is provided a method of acquiring music for an operator of a public medium to play in said medium comprising the following steps:
arranging with the operator to find a provider of music based on a set of criteria;
selecting an appropriate provider of music based on said set of criteria; and
arranging for the provider of music to acquire from the operator a right to play a selection of music in said public medium.

According to yet another aspect of the present invention, there is provided a method of arranging a business transaction comprising the following steps:
selecting a provider of music;
selecting an operator of a public medium wherein said medium is appropriate for playing music of the provider of music based on a set of pre-determined criteria provided by said operator; and
arranging for the provider to acquire from the operator a right to play a selection of music in said public medium.

According to another aspect of the present invention, there is provided a method of conducting a business transaction between a provider of music and an operator of a public medium comprising the step of arranging for the acquisition of a right to play a selection of music in said public medium by the provider from the operator.

According to another aspect of the present invention, there is provided a method for an operator of a public medium to acquire music for playing in said public medium comprising the step of transferring to a provider of music a right to play a selection of music in said public medium.

According to another aspect of the present invention, there is provided a method for a provider of music to acquire the right to play music in a public medium comprising the step of acquiring from an operator of a public medium a right to play a selection of music in said public medium.

### BRIEF DESCRIPTION OF THE DRAWINGS

FIG. 1 is a schematic depicting a preferred embodiment of the present business method.

### DETAILED DESCRIPTION OF THE INVENTION

The invention is a business method that involves arranging for a provision of music from a provider of music to an operator of a public medium.

For the purposes of the present invention, music includes musical recordings, live performances of music, live performances of music or musical recordings delivered by audio or audio-visual means including personal communication device ring tones such as mobile phone ring tones or ring songs, internet broadcasts and music embodied as a component of an audio or audio-visual production (i.e. music embodied within a music video or theatrical film trailer).

A provider of music is an individual or organization that controls the performance, exploitation, reproduction, and/or distribution of the music or has the right to give permission to third parties to do the same or to play or perform the music in public. Providers of music include a record company, a music publishing company, a distribution company, a record producer, a recording studio, an individual artist, an individual, a music provider and an agent for musical artists.

For the purposes of the present invention, a public medium includes any medium for playing music that is accessible by members of the public either for a fee or free of charge. Television and radio are not public media for the purposes of the present invention. Examples of public media include retail stores, bars, event and motion picture theatres, sports stadiums, sports arenas, mobile phone ring tones and songs and other personal information and communication device ring tones and songs, phone line holding ports and on-line websites. This list is not meant to be exhaustive. Other public media other than radio or television are also within the scope of the present invention.

According to the present invention an operator of a public medium preferably sells a period of time to a provider of music to play its music over the medium. Alternatively in other cases such as where the public medium may be an Internet website, access to the music may be limited to the number of times that the website is visited. An agent may broker the arrangement and optionally choose the music to be played over the public medium. Alternatively, the operator and the provider of music may work together to determine content if the operator so chooses.

There are benefits realizable by each party. The operator, instead of suffering a cost to have music performed in its public medium, generates a revenue flow while also receiving music, the musical benefit of which may be passed along to the operator's customers. The provider of music realizes exclusive exposure of it's chosen music. This is beneficial for marketing and promotional purposes.

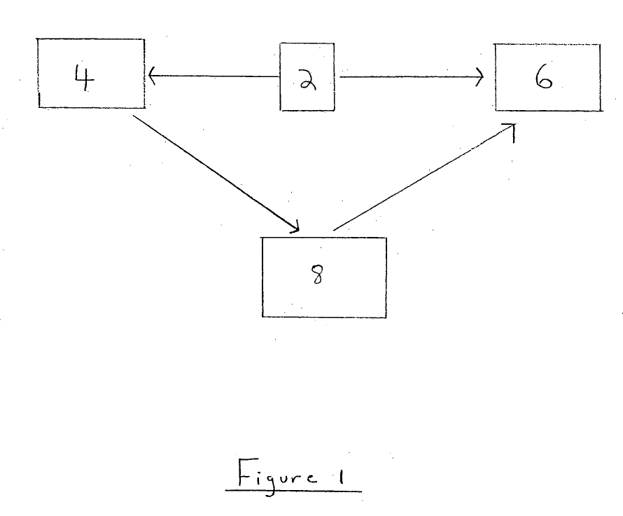

A preferred implementation of the present invention is depicted in FIG. 1. An agent 2 preferably acts as an intermediary between an operator of a public medium 4 and a provider of music 6. The agent preferably brokers a deal whereby the provider of music purchases from the operator preferably a block of time on the medium for which the provider of music may play a selection of music agreed upon between the provider of music and the operator. Preferably, the agent uses his or her judgment in linking an appropriate provider of music with a correspondingly appropriate operator. The agent preferably considers several factors including; (i) the type of music that a specific provider of music wishes to promote; (ii) the type of ambiance that an operator wishes to create over its medium; (iii) a coordination between the demographic factors (including factors such as age, sex, location, economic status, consumer goods purchasing behaviours) of the patrons of the public space with the demographic factors of the sorts of patrons the music provider wishes to promote its music.

The agent preferably administers the payment of the required licensing fees that will be payable to the appropriate copyright collective or collectives 8 for the acquisition of music rights by the provider of music and for the public performance of the music on the operator's medium.

According to other implementations of the invention, the agent can act for either an operator, provider of music or both in brokering an arrangement whereby the provider of music acquires time from the operator to play its music over the medium. The provider of music and owner can acquire the time for example through an exchange of goods or services or by paying the owner cash. The arrangement could be structured such that the right to play music is in specified portions of the medium. Therefore separate business arrangements could be structured for separate portions of a public medium. This could for example be different departments of a department store.

According to yet other implementations of the invention, there is no agent and the provider of music buys time directly from the operator to play its music over the operator's medium. In such a case the license fees would be paid directly by either the operator or the provider of music to the applicable copyright or public performance collective. Other implementations of the invention whereby a provider of music either directly or indirectly purchases time from an operator to play its music over its medium are within the scope of the present invention. Other implementations of the invention whereby a provider of music either directly or indirectly purchases a right from an operator to play its music over its medium are within the scope of the present invention. This right may be limited to the occurrence of specified number of events such as visits to a website or occasions that a mobile phone rings.

### EXAMPLES

The following are examples of implementations of the present invention.

### Example 1

### Retail Store

An owner of a retail store as an operator of a public medium sells a period of time in a given day or multiple days to a provider of music, during which that provider of music's music is played exclusively in the medium. This permits the provider of music to accomplish a high level of exposure of its selected music to the people attending at the retail store. The provider of music could select music featuring a single artist or multiple artists that it wants exposed and promoted. This scenario also allows for an additional benefit of cross-promotion between the operator and its retail products and the provider of music and its music. For example, a retailer could sell a number of hours in a day to a record production company during which the retailer would play only music featuring artists signed with the record production company or a single artist of the record production company. The record production company could erect visual displays and undertake other promotional efforts (such as point-of-purchase displays and cross-promotions between an artist and a selected artist-endorsed retailer product) to bring attention the music. It is also possible for the retailer to sell rights to play music in individual areas of a retail store such as men's clothing, women's clothing, fragrances section etc. The right to play music in each of these different sections could be structured as a separate transaction. The record company could also provide free goods to the owner as an alternative to or for a reduction of money payments to the owner, which goods could be sold by owner or given away by owner in cross-promotion of other goods sold in owner's premises. To the benefit of the record production company, this allows for concentrated and expansive exposure and advertisement for the music of the chosen artist(s), potential revenue generation paid by the product manufacturer from product endorsement and a possible beneficial goodwill association between the record production company and the retailer. To the benefit of the retailer, this allows for revenue generation through the sale of the time period (whereas they previously may have had to pay an existing music provider to receive music and which would offset any public performance fees payable to a copyright collective for which it may be responsible for the public performance of music in their store) and a possible beneficial goodwill association or endorsement between the retailer's products and the record production company or the retailer's products and a particular artist. The particular demographic of the retailer's customers could be analyzed and matched with chosen demographics for the record production company or the selected record production company's artist(s).

### Example 2

### Restaurants

A restaurant could sell a period of time in a given day or multiple days to a provider of music, during which that provider of music's music is played exclusively. In this case the public medium is the restaurant and the operator is the operator of the restaurant. This permits the provider of music to accomplish a high level of exposure of its selected music to the people attending at the restaurant. The provider of music selects music featuring a single artist or multiple artists that it wants exposed and promoted. This scenario also allows for an additional benefit of cross-promotion between the operator and/or its products and services and the provider of music and its music. For example, a restaurant could sell a portion of a night or a whole night to a record production company during which the operator would play only music featuring the record production company's artists or a single record producer artist. The record production company could erect visual displays and undertake other promotional efforts and point-of-purchase displays to bring attention the music. To the benefit of the record production company, this allows for concentrated and expansive exposure and advertisement for the music of the chosen artist(s) and a possible beneficial goodwill association between the operator and the record production company. To the benefit of the operator, this allows for revenue generation through the sale of the time period (whereas they previously may have had to pay an existing music provider to receive music and which would offset any public performance fees payable to a copyright collective for which it may be responsible for the public performance of music in their restaurant) and a possible beneficial goodwill/endorsement association between the operator's food and beverage products and the record production company, or the operator's products and services and an artist. The particular demographic of the operator's customers could be analyzed and matched with chosen demographics for the record production company or its selected artist(s). The record label could also provide free goods to the restaurant as an alternative to or for a reduction of money payments to the operator, which goods could be used to induce attendance by or generate goodwill with patrons of the restaurant.

### Example 3

### Stadium or Arena

A stadium or arena sells a period of time during a given event or multiple events to a provider of music, during which that provider of music's music is played exclusively. In this example the public medium is a stadium or arena. According to the present business method, the music would be provided to an arena or stadium for playing at non-musical concert events such as a hockey game or a baseball game. The music would be played between, face-offs, periods or innings as appropriate. This permits the provider of music to accomplish a high level of exposure of its selected music to the people attending at the stadium or arena for events. The provider of music could select music featuring a single artist or multiple artists that it wants exposed and promoted. For example, an arena could sell a portion of the time of an event or a whole event during which music is capable of being publicly performed to a record label, during which the record label would play only music featuring the record label artists or a single record label artist. The record label could also erect visual and point-of-purchase displays and undertake other promotional efforts at the arena or stadium to bring attention to the record label's music. To the benefit of the record label, this allows for concentrated and expansive exposure and advertisement for the music of the chosen artist(s) and a possible beneficial goodwill association between the record label and the arena or stadium and/or teams competing therein. To the benefit of the arena or stadium, this allows for revenue generation through the sale to a provider of music of the time period (whereas they previously may have had to pay an existing music provider to receive music and which would offset any public performance fees payable to a copyright collective for which it may be responsible for the public performance of music in their arena or stadium) and a possible beneficial goodwill/endorsement association between the arena or stadium and the record label, or the arena or stadium and an artist. The particular demographic of the arena's or stadium's attendees for a given event could be analyzed and matched with chosen demographics for the record label or the selected record label artist(s).

### Example 4

### Telephone Holding Systems

A company which accepts orders for its goods and/or services over the telephone sells a period of time to a provider of music during which the company's customers may be placed on-hold and during which that provider of music's music is played exclusively. This would permit the provider of music to accomplish a high level of exposure of its selected music to the people accessing the company's goods and/or services. The provider of music could select music featuring a single artist or multiple artists that it wants exposed and promoted. To the benefit of the provider of music, this allows for concentrated and expansive exposure and advertisement for the music of the chosen artist(s) and a possible beneficial goodwill association between the provider of music and the company. To the benefit of the company, this allows for revenue generation through the sale of the on-hold time period (whereas they previously may have had to pay an existing music provider to receive music and which would offset any public performance fees payable to a copyright collective for which it may be responsible for the public performance of music during on-hold periods) and a possible beneficial goodwill association/endorsement between the company and it products and the provider of music. The particular demographic of the company's customers could be analyzed and matched with chosen demographics for the provider of music and its artist(s). The provider of music could provide free goods or services to the company that could be used by the company as promotion to induce consumers to order the company's goods and/or services by telephone.

### Example 5

### Internet

An operator of an internet website sells a period of time or number of web-hits to a provider of music during which visitors to the site would be automatically streamed and/or offered free downloads of exclusively that provider of music's music while the visitors are accessing the website. This would permit the provider of music to accomplish a high level of exposure of its selected music to the people accessing the website. The provider of music could select music featuring a single artist or multiple artists that it wants exposed/promoted. For example, an internet provider could sell a portion of the time or a number of web-hits to a music company during which people accessing the internet provider's website may be automatically streamed music featuring the music company's artists or a single music company artist. Other cross-promotional efforts, such as Java script and hyperlinks could be used to bring attention to the music company's music. To the benefit of the music company, this allows for concentrated and expansive exposure and advertisement for the music of the chosen artist(s) and a possible beneficial goodwill association between the music company and the Internet provider. To the benefit of the operator of the internet website, this allows for revenue generation through the sale of the time periods or number of web-hits (whereas they previously may have had to pay an existing music provider to receive music and which would offset any public performance fees payable to a copyright collective for which it may be responsible for the public performance of music over the internet), a possible beneficial goodwill association/endorsement between the internet provider and its products and the music company or its artists, and an effective promotional tool in streamed or downloaded music which is free of any cost, expense or charge to the customer whether such cost, expense or charge is direct or indirect by, for example coupons acquired through purchase by the consumer of some other product or service, which draws consumers to the website. The particular demographic of the Internet provider's visitors could be analyzed and matched with chosen demographics for the music company or the selected music company artist(s). The music company could provide other free goods or services to the company as an alternative to or for a reduction of money payments to the website, which goods could be used by the company as promotion to induce consumers to visit the website.

### Example 6

### Ring Tones

A telecommunications company or mobile phone network company sells the right to play a given provider of music's music as ring tones or ring songs on the telephones used by that company's customers. This permits the provider of music to accomplish a high level of exposure of its selected music to the company's customers and people within listening range of the ringing telephone. The provider of music could select music featuring a single artist or multiple artists that it wants exposed and promoted. For example, the company could agree to, on an exclusive basis, make a provider of music's music available to the company's subscribers as ring tones or ring songs for a given period of time (free of charge or at reduced cost) or could automatically send the music (also known as “pushing” music content) to the company subscriber's cell phones as a message from the company thereby making same available to its subscribers as a ring tone or ring songs at no cost to the subscriber receiving the pushed music. The company could also distribute text or other visual messages, as well as, promotional flyers and mail inserts to bring attention to the provider of music's music. To the benefit of the provider of music, this allows for concentrated and expansive exposure and advertisement for the music of the chosen artist(s) and a possible beneficial goodwill association between the provider of music and the company. To the benefit of the company, this allows for revenue generation through the sale of the right to play the provider of music's music as ring tones or ring songs (whereas they or their customers previously may have had to pay an existing music provider to receive ring tones or ring songs and which would offset any public performance fees payable to a copyright collective for which it may be responsible for the public performance of music as ring tones or ring songs) and a possible beneficial goodwill association/endorsement between the company's products and the provider of music, or the company's products and an artist. The particular demographic of the company's customers could be analyzed and matched with chosen demographics for a provider of music or the selected provider of music's artist(s).

### Example 7

### Music Videos and Movie Trailers on Hand-Held Devices

A telecommunications company sells the right to play a given record company artist's video or movie company's promotional movie trailer (which includes background music) over the telecommunications company's network to the hand held devices (including personal communication devices and personal digital assistants) utilized by that telecommunication company's customers. This permits the record company or movie company to accomplish a high level of exposure of their selected audio-visual content to the telecommunications company's customers. The audio-visual content selected by the record company or movie company could be made available to telecommunication company's customers as free streamable or free downloadable content or alternatively could automatically be sent to them as a message from the telecommunications company (also known as “pushing” content) free of charge and, for a period of time, on an exclusive basis. The telecommunications company could also distribute text or other visual messages, as well as, promotional flyers and mail inserts to bring attention to the free exclusive access to the selected audio-visual content. To the benefit of the record or movie company, this allows for concentrated and expansive exposure for the selected audio-visual content and a possible beneficial goodwill association between the record or movie company and the telecommunications company. To the benefit of the telecommunications company, this allows for revenue generation through the sale of the right to play the selected audio-visual content (whereas previously they or their customers may have had to pay to receive such content and which revenue would offset any public performance fees payable to a copyright collective for which the telecommunication company may be responsible for the public performance of such audio-visual content), an effective promotional tool in streamed or downloaded video which is free of any cost, expense or charge to the customer whether such cost, expense or charge is direct or indirect by, for example coupons acquired through purchase by the consumer of some other product or service, which draws consumers to the website and a possible beneficial goodwill association/endorsement between the telecommunications company's products or services and the record company (or a particular artist) or the movie company (or a movie or actor). The particular demographic of the telecommunications company's customers could be analyzed and matched with chosen demographics for a record company (or its artist) or movie company (or movie).

Although the invention has been described with preferred embodiments, it is to be understood that modifications may be resorted to as will be apparent to those skilled in the art. Such modifications and variations are to be considered within the purview and scope of the present invention.

1. A method of arranging for a provision of music from a provider of music to an operator of a public medium comprising the following steps:
acquiring from the operator a right to play a selection of music in said public medium; and
transfering said right to play music to the provider of music.

2. A method according to claim 1 further comprising the following steps:
delivering said selection of music from said provider of music to said operator; and
playing said selection in said public medium.

3. A method according to claim 1 further comprising the step of selecting the operator.

4. A method according to claim 1 further comprising the step of selecting the provider of music.

5. A method according to claim 4 further comprising the step of selecting the operator.

6. A method according to claim 1 further comprising the step of selecting from the provider of music an appropriate selection of music to play in said public medium.

7. A method according to claim 1 further comprising the step of arranging for the payment of copyright license fees to the owners of a copyright subsisting in said music.

8. A method according to claim 1 wherein the public medium is selected from a group consisting of retail stores, bars, sports stadiums, sports arenas, hand-held devices including personal communication devices, mobile phones and personal digital assistants, phone line holding ports and on-line websites.

9. A method according to claim 1 wherein the provider of music is selected from a group consisting of a record company, a record producer, a music publisher, record distributer, a recording studio, an individual artist, an individual, a music provider and an agent for musical artists.

10. A method according to claim 1 wherein the right to play a selection of music in said public medium is at a pre-determined time and for a pre-determined length of time.

11. A method of acquiring music for an operator of a public medium to play in said medium comprising the following steps:
arranging with the operator to find a provider of music based on a set of criteria;
selecting an appropriate provider of music based on said set of criteria; and
arranging for the provider of music to acquire from the operator a right to play a selection of music in said public medium.

12. A method according to claim 11 further comprising the step of delivering said music from the provider of music to the operator.

13. A method according to claim 11 wherein the provider of music is selected according to a pre-selected set of criteria provided by the operator.

14. A method according to claim 11 further comprising the step of selecting from the provider of music an appropriate selection of music to play in said public medium.

15. A method according to claim 11 further comprising the step of arranging for the payment of copyright license fees to the owners of a copyright subsisting in said music.

16. A method according to claim 111 wherein the public medium is selected from a group consisting of retail stores, bars, sports stadiums, sports arenas, hand-held devices including personal communication devices, mobile phones and personal digital assistants, phone line holding ports and on-line websites.

17. A method according to claim 11 wherein the provider of music is selected from a group consisting of a record company, a record producer, a music publisher, a record distributer, a recording studio, an individual artist, a music provider and an agent for musical artists.

18. A method according to claim 11 wherein the right to play a selection of music in said public medium is at a pre-determined time and for a pre-determined length of time.

19. A method of arranging a business transaction comprising the following steps:
selecting a provider of music;
selecting an operator of a public medium wherein said medium is appropriate for playing music of the provider of music based on a set of pre-determined criteria provided by said operator; and
arranging for the provider to acquire from the operator a right to play a selection of music in said public medium; and

20. A method according to claim 19 further comprising the step of arranging for the payment of copyright license fees to the owners of a copyright subsisting in said music.

21. A method according to claim 20 wherein the public medium is selected from a group consisting of retail stores, bars, sports stadiums, sports arenas, hand-held devices including personal communication devices, mobile phones and personal digital assistants, phone line holding ports and on-line websites.

22. A method according to claim 21 wherein the provider of music is selected from a group consisting of a record company, a record producer, a music publisher, a record distributer, a recording studio, an individual artist, a music provider and an agent for musical artists.

23. A method according to claim 19 wherein the right to play a selection of music in said public medium is at a pre-determined time and for a pre-determined length of time.

24. A method of conducting a business transaction between a provider of music and an operator of a public medium comprising the step of arranging for the acquisition of a right to play a selection of music in said public medium by the provider from the operator.

25. A method according to claim 24 wherein the right to play a selection of music in said public medium is at a pre-determined time and for a pre-determined length of time.

26. A method for an operator of a public medium to acquire music for playing in said public medium comprising the step of transfering to a provider of music a right to play a selection of music in said public medium.

27. A method according to claim 26 wherein the right to play a selection of music in said public medium is at a pre-determined time and for a pre-determined length of time.

28. A method for a provider of music to acquire the right to play music in a public medium comprising the step of acquiring from an operator of a public medium a right to play a selection of music in said public medium.

29. A method according to claim 28 wherein the right to play a selection of music in said public medium is at a pre-determined time and for a pre-determined length of time.

30. A method according to claim 19 wherein there is no cost to a member of the public for accessing said music from said public medium.
